(19) United States
(12) Patent Application Publication
(10) Pub. No.: US 2005/0096425 A1
(43) Pub. Date: May 5, 2005

(54) High stability polytetrafluoroethylene dispersions and method for obtaining same

(76) Inventors: Michael Coates, Moorestown, NJ (US); Wes Demonde, Newtown Square, PA (US); Kurt Davidson, Collegeville, PA (US)

Correspondence Address: BAKER & DANIELS;111 E. WAYNE STREET, SUITE 800, FORT WAYNE, IN, 46802, US

(21) Appl. No.: 10/947,531

(22) Filed: Sep. 22, 2004

Related U.S. Application Data
(60) Provisional application No. 60/506,036, filed on Sep. 25, 2003.
(60) Provisional application No. 60/549,667, filed on Mar. 3, 2004.

(51) Int. Cl. C08K 3/00

(52) U.S. Cl. 524/500

(57) ABSTRACT

A process for stabilizing aqueous dispersions of polytetrafluoroethylene (PTFE) or co- and terpolymers of PTFE by adding a macromolecular species directly to the aqueous dispersion. Surprisingly, it has been observed that after the macromolecular species has been added to the dispersion of PTFE or co- and terpolymers of PTFE, the dispersions are very stable, do not readily coagulate, and remain stable even when subjected to freeze/melt cycles. The amount of macromolecular species which may be added may vary from about 0.1 wt. % to about 20.0 wt. %, for example, and suitable macromolecular species include polyacrylic acid (PAA), polyvinylalcohol (PVOH), polyethyleneimies (PEI), and polyethylene glycol (PEG), and others. The present method is particularly effective for stabilizing commercially available “unstabilized” aqueous dispersions of PTFE or co- and terpolymers of PTFE which do not include a surfactant or are substantially free of surfactant.

### CROSS REFERENCE TO RELATED APPLICATIONS

This application claims the benefit under Title 35, U.S.C. § 119(3) of U.S. Provisional Patent Application Ser. No. 60/506,036, entitled HIGH STABILITY POLYTETRAFLUOROETHYLENE DISPERSIONS AND METHOD FOR OBTAINING SAME, filed on Sep. 25, 2003, as well as U.S. Provisional Patent Application Ser. No. 60/549,667, entitled HIGH STABILITY POLYTETRAFLUOROETHYLENE DISPERSIONS AND METHOD FOR OBTAINING SAME, filed on Mar. 3, 2004.

### BACKGROUND OF THE INVENTION

1. Field of the Invention

The present invention relates to a method of treating aqueous fluoropolymer dispersions to increase the stability thereof. In particular, the present invention relates to a method of treating aqueous dispersions of polytetrafluoroethylene (PTFE) or co- and terpolymers of PTFE.

2. Description of the Related Art

Historically, aqueous dispersions of polytetrafluoroethylene (PTFE) or co- and terpolymers of PTFE from commercial sources have typically been produced by polymerizing tetrafluoroethylene (TFE) in water using a small amount of a fluorosurfactant, typically ammonium perfluorooctanoate (APFO), and a hydrocarbon which is subsequently removed. The dispersion latex so produced typically contains about 30.0 wt. % PTFE. PTFE particles are highly hydrophobic, such that aqueous PTFE dispersions are inherently very unstable. Therefore, these types of aqueous PTFE dispersions will readily coagulate with a small amount of shear or agitation, or simply upon standing after a short amount of time. Additionally, these dispersions cannot undergo freeze/melt cycles, or any great variation in temperature without coagulating. Coagulation is defined as an irreversible flocculation of the PTFE particles, which results in the formation of two layers. The top layer is a relatively clear liquid and the bottom layer is a mud-like layer. Once an aqueous PTFE dispersion coagulates, the PTFE cannot be practicably re-dispersed. Agglomeration, by contrast, is defined as the association of two or more of the particles of the PTFE dispersion which can form small clear layers, however, agglomeration is generally reversible with the correct amount of agitation.

To increase the stability of PTFE dispersions, the currently accepted production method is to very quickly add between approximately 3.0 wt. % and 8.0 wt. % of a classic surfactant to the unstable aqueous PTFE dispersion. The surfactant is typically either ionic, such as sodium sulfate salts of short chain aliphatic hydrocarbons, or non-ionic, such as ethoxylated alkyl phenols or ethoxylated aliphatic alcohols. The dispersion is then usually concentrated to greater than 50.0 wt. % solids. Virtually all commercially available aqueous dispersions of PTFE are of this type. For example, one known commercially available aqueous PTFE dispersion contains approximately 60.0 wt. % of 0.25 micron PTFE resin particles suspended in water, and the dispersion additionally includes approximately 8.0 wt. % of a nonionic wetting agent and surfactant to stabilize the dispersion.

Aqueous PTFE or co- and terpolymers of PTFE dispersions which do not include surfactants are available from commercial sources. However, these dispersions are expectedly unstable, and are therefore used only for specialized applications in which the dispersions can be used very quickly and before the dispersions coagulate.

What is needed is a method of stabilizing aqueous dispersions of PTFE and co- and terpolymers of PTFE which does not require the addition of a surfactant, and which is an improvement over the foregoing.

### SUMMARY OF THE INVENTION

The present invention provides a process for stabilizing aqueous dispersions of polytetrafluoroethylene (PTFE) or co- and terpolymers of PTFE by adding a macromolecular species directly to the aqueous dispersion. Surprisingly, it has been observed that after the macromolecular species has been added to the dispersion of PTFE or co- and terpolymers of PTFE, the dispersions are very stable, do not readily coagulate, and remain stable even when subjected to freeze/melt cycles. The amount of macromolecular species which may be added may vary from about 0.1 wt. % to about 20.0 wt. %, for example, and suitable macromolecular species include polyacrylic acid (PAA), polyvinylalcohol (PVOH), polyethyleneimies (PEI), polyethylene glycol (PEG), and others. The present method is particularly effective for stabilizing commercially available “unstabilized” aqueous dispersions of PTFE or co- and terpolymers of PTFE which do not include a surfactant or are substantially free of surfactant.

Advantageously, the present process provides a method of stabilizing aqueous dispersions of PTFE or co- and terpolymers of PTFE, such as commercially available aqueous dispersions of PTFE or co- and terpolymers of PTFE, which are otherwise very unstable and require the addition of a surfactant in order to stabilize the dispersions. In this manner, the need for a surfactant is obviated, thereby reducing the cost of preparing stable dispersions of PTFE or co- and terpolymers of PTFE. In addition, the macromolecular species which are added to the aqueous dispersions in order to stabilize same are inexpensive, and are readily obtainable from many commercial sources. Further, the macromolecular species may be added directly to the dispersions, such as by mixing the macromolecular species in solid, liquid, or aqueous solution form into the dispersions. In this manner, specialized equipment and processes are not required.

In one form thereof, the present invention provides a process for stabilizing an aqueous dispersion of at least one of polytetrafluoroethylene, co-polymers of polytetrafluoroethylene, and terpolymers of polytetrafluoroethylene, including the steps of: providing an aqueous dispersion of at least one of polytetrafluoroethylene, co-polymers of polytetrafluoroethylene, and terpolymers of polytetrafluoroethylene; and adding directly to said dispersion from about 0.1 wt. % to about 20.0 wt. % of a macromolecular species.

In another form thereof, the present invention provides an aqueous dispersion of at least one of polytetrafluoroethylene, co-polymers of polytetrafluoroethylene, and terpolymers of polytetrafluoroethylene, the aqueous dispersion comprising from about 0.1 wt. % to about 20.0 wt. % of at least one macromolecular species and being substantially free of surfactant.

In another form thereof, the present invention provides an aqueous dispersion of at least one of polytetrafluoroethylene, co-polymers of polytetrafluoroethylene, and terpolymers of polytetrafluoroethylene, the aqueous dispersion comprising from about 0.1 wt. % to about 20.0 wt. % of at least one macromolecular species.

In a further form thereof, the present invention provides an aqueous dispersion, including from about 10.0 wt. % to about 70.0 wt. % of at least one of polytetrafluoroethylene, co-polymers of polytetrafluoroethylene, and terpolymers of polytetrafluoroethylene; less than about 1.0 wt. % of a surfactant; and from about 0.1 wt. % to about 20.0 wt. % of at least one macromolecular species.

### DETAILED DESCRIPTION

Suitable unstabilized aqueous dispersions of one or more of PTFE, co-polymers of PTFE, or terpolymers of PTFE which may stabilized according to the present process include aqueous dispersions in which PTFE is polymerized directly from tetrafluoroethylene (TFE) in water according to known techniques. Other aqueous dispersions of one or more of PTFE, co-polymers of PTFE, or terpolymers of PTFE which may be stabilized according to the present process include aqueous dispersions of one or more of PTFE, co-polymers of PTFE, or terpolymers of PTFE which are formed by dispersing one or more of PTFE, co-polymers of PTFE, or terpolymers of PTFE particles in water. Commercially, theses polymers are classed as FEP, PFA and MFA dispersions. Alternatively, “unstabilized” commercial dispersions of PTFE, co-polymers of PTFE, and terpolymers of PTFE, which do not include a surfactant and therefore have very limited stability, may also be stabilized according to the present process. These types of aqueous dispersions of PTFE, co-polymers of PTFE, and terpolymers of PTFE are available from many commercial sources, such as AD058 and AD 307 PTFE dispersions, available from Asahi Glass Fluoropolymers USA, Inc., D3 or D2 dispersions, available from Daikin America, Inc., and FEP 121A, available from DuPont.

Typically, the unstabilized dispersions of one or more of PTFE, co-polymers of PTFE, and terpolymers of PTFE which may be stabilized according to the present process, contain at least 10.0 wt. % fluoropolymer solids, preferably at least 20.0 wt. % solids, more preferably at least 30.0 wt. % solids. After stabilization and concentration, the fluoropolymer solids content may be as high as 50 wt. %, more preferably at high as 60.0 wt. %. The average particle size of the fluoropolymer usually ranges from between about 0.03 microns and about 1.0 microns, with the average particle size preferably in the range of between about 0.1 microns and about 0.35 microns.

These dispersions are substantially free of surfactants which, as used herein, means that the dispersions do not contain surfactants at all, or contain only trace amounts of surfactant, such as less than about 1.0 wt. % of a surfactant, more preferably, less than about 0.5 wt. % of a surfactant. Typical surfactants include APFO, for example, which is added prior to or during polymerization to stabilize the dispersion.

Surfactants are used to produce a dispersion of one or more of PTFE, co-polymers of PTFE, and terpolymers of PTFE in water that is only sufficiently stable to withstand the polymerization process, and which requires additional standard surfactants to produce a commercially saleable, stable product. These surfactants characteristically include molecules having a hydrophilic part and hydrophobic part, and a relatively low molecular weight, with the carbon number of each molecule typically between C4 and C-20. These surfactants are unlike the macromolecular species used according to the present process which, as described below, have only hydrophilic groups on their molecular chains, have carbon numbers much greater than C-20, and are essentially oligomers of a repetitive monomer unit.

As used herein, a dispersion of one or more of PTFE, co-polymers of PTFE, and terpolymers of PTFE which is “substantially free” of surfactant means a dispersion of one or more of PTFE, co-polymers of PTFE, and terpolymers of PTFE which includes less than about 1.0 wt % of surfactant.

According to the present process, one or more macromolucular species is added to the foregoing types of unstabilized aqueous dispersions in order to stabilize the dispersions. For example, the macromolecular species in solid, liquid, or aqueous dispersion form may be added to such an aqueous dispersion with agitation, such as light mixing or stirring. The amount of macromolecular species which may be added may vary from about 0.1 wt. % to about 20.0 wt. %, preferably from about 0.15 wt. % to about 10.0 wt. %, more preferably from about 0.25 wt. % to about 4.0 wt. %, based upon the weight of the PTFE. After addition of the macromolecular species, the aqueous dispersions are very stable, and do not readily separate into fluoropolymer and water layers.

Suitable macromolecules which may be used according to the present process include macromolecules having hydrophilic repetitive units, such as polyvinyl alcohols (PVOH), polylactic acids, polyamidimides (PAI), polyacrylamides, polyvinylamines, polyallylamines, polyethyleneimines, poly vinyl pyrrilidones (PVP), polyvinylpyridines, polyethylene glycol (PEG), poly acrylic acid (PAA), polyacrylates, polymethacrylates, polysaccharides, copolymers of the foregoing, and mixtures of the foregoing. The molecular weight of the macromolecular species will typically vary from about 300 to about 100,000 or more, preferably from about 1,200 to about 90,000. As used herein, the term “macromolecule” refers to any relatively large molecular weight molecule having a number of one or several relatively simple types of structural units, each structural unit consisting of several atoms bonded together.

The macromolecules suitable for use in the present invention may also include oligomer molecules (or “oligomeric molecules” or “oligomers”), which are molecules of intermediate relative molecular mass, the structure of which essentially comprises a small plurality of units derived, actually or conceptually, from molecules of lower relative molecular mass. For the purposes of this disclosure, a molecule is regarded as having an “intermediate relative molecular mass” if it has properties which do not vary significantly with the removal of one or a few of the units.

According to the present process, aqueous dispersions of one or more of PTFE, co-polymers of PTFE, and terpolymers of PTFE are stabilized by adding the macromolecular species thereto, without the need to add a surfactant. In fact, it has been surprisingly found that the addition of a macromolecular species alone to an otherwise “unstable” dispersion of one or more of PTFE, co-polymers of PTFE, and terpolymers of PTFE which does not include a surfactant, or includes only trace amounts of a surfactant, markedly increases the stability of the dispersion. However, if desired, a surfactant may optionally be added to the PTFE dispersions after the addition of the macromolecular species to increase the “wetting” characteristics of the dispersion. Adding surfactant to the dispersions after the macromolecular species retains the benefit of adding the macromolecular species. However, adding the surfactant before the macromolecular species can decrease the stability of the dispersions. At this time, it is believed that when the macromolecular species is added to the dispersion, the macromolecular species is prevented from aligning on the surfaces of the PTFE particles if there is a significant presence of surfactant or other surface active material.

Although the specific chemical interactions by which the macromolecular species stabilizes the fluoropolymer particles in aqueous solution are not completely understood, it is thought that potions of the macromolecular species, such as the functional groups thereof, interact with the fluoropolymer particles forming a stable layer on the surface of the particles, while other, hydrophilic portions of the macromolecular species interact with the water molecules. In this manner, the macromolecular species provides a hydrophilic interface which stabilizes the otherwise hydrophobic fluoropolymer particles in aqueous solution. Also, the larger size of the macromolecule may also give a form of stearic hindrance to the agglomeration/coagulation process.

After the aqueous PTFE dispersions are stabilized, the macromolecular species may be optionally physically attached to the PTFE particles by subjecting the dispersion to high energy treatment as disclosed in U.S. patent application Ser. No. 10/345,541, entitled METHOD FOR TREATING FLUOROPOLYMER PARTICLES AND THE PRODUCTS THEREOF, filed on Jan. 16, 2003 (Attorney Docket Ref.: LPL0002-01), assigned to the assignee of the present invention, the disclosure of which is expressly incorporated herein by reference.

### EXAMPLES

The following non-limiting examples illustrate various features and characteristics of the present invention which are not to be construed as limited thereto. Throughout the Examples and elsewhere herein percentages are by weight unless otherwise indicated.

### Example I

### Addition of Macromolecular Species to Aqueous PTFE Dispersions

In this example, aqueous PTFE dispersions were provided having a PTFE solids content varying between 30.0 wt. % and 60.0 wt. %, with the size of the PTFE particles varying in size between 0.1 microns and 6.0 microns, as set forth in Table I below. Polyacrylic acid (PAA) of 90,000 molecular weight and polyvinyl alcohol (PVOH) of 15,000 molecular weight were added with mixing directly to the aqueous PTFE dispersions in small 3 inch glass phials at amounts varying between 0.2 wt. % and 10.0 wt. %, based upon the weight of each dispersion.

The dispersions were allowed to stand, and in most of the cases, the lattices of the mixtures appeared to be stable. The mixtures did not readily separate into water and fluoropolymer layers, and the mixtures did not coagulate. In some of the test runs below, only a very small layer of water appeared at the top of the latex after passage of the indicated time. The time to eventual coagulation for each of the test runs was measured; however, for many of the test runs, such as runs 3-6, no coagulation was observed even after 6 months.

Thus, a great improvement in stability was observed as compared to control test run 14, to which no macromolecular species or surfactant was added. The stability of the dispersions of runs 5 and 6, to which only macromolecular species was added, was comparable to that of control run 4, to which only a traditional non-ionic surfactant was added. In the samples which did coagulate, PTFE particles settled to the bottom of the glass phial, forming a solids layer that could not be re-suspended into the original dispersion.

Additionally, test runs 2-7 were subjected to a freeze/melt cycle wherein each sample was frozen in a commercial freezer, and then gradually allowed to return to room temperature. Runs 2 and 5-7 were found to be freeze/melt stable, while runs 3 and 4 were not. Sodium silicate was added to the dispersions of runs 10-14, with the indicated results, and the dispersion of run 12 was irradiated according to the above-incorporated U.S. Patent Application Ser. No. 10/345,541. In runs 10-14, sodium silicate was added to demonstrate that the dispersions were stable even in the presence of high ionic strength, as compared to standard dispersions which demonstrate dispersion instability.

TABLE 1

| | PTFE Dispersion (PTFE | | Macromolecular | | Freeze/ |
|---|---|---|---|---|---|
| | concentration and PTFE | | species added | Stability, time | thaw |
| Run | particle size) (wt. %). | Surfactant | (wt. %). | to coagulation. | stability |
| 1 | 30.0% solids | None | PAA, 0.2% | Less than one | |
| | dispersion at 0.25 | | | week. | |
| | microns | | | | |
| 2 | 30.0% solids | None | PAA, 0.95% | Good. 2+ | Yes |
| | dispersion at 0.25 | | | months | |
| | microns | | | | |
| 3 | 30.0% solids | 6.0%, non- | PAA, 0.95% | Good. 6+ | No |
| | dispersion at 0.25 | ionic | | months | |
| | microns | | | | |
| 4 | 60.0% solids | 6.0%, non- | None. | Good. 6+ | No |
| | dispersion at 0.25 | ionic | | months | |
| | microns | | | | |
| 5 | 60.0% solids | None | PAA, 0.95% | Good. 6+ | Yes |
| | dispersion at 0.25 | | | months | |
| | microns | | | | |
| 6 | 30.0% solids | None | PVOH, | Good. 6+ | Yes |
| | dispersion at 0.25 | | 2.0% | months | |
| | microns | | | | |
| 7 | 40.0% solids | None | PAA, 2% | Settles. Does | Yes |
| | dispersed at | | | not coagulate | |
| | 6.0 microns | | | | |
| 8 | 30.0% solids | None | PAA, 4.0% | Good. More | |
| | dispersion at 0.25 | | | than 1 week. | |
| | microns | | | | |
| 9 | 30.0% solids | None | PAA, 10.0% | Good. More | |
| | dispersion at 0.25 | | | than 1 week. | |
| | microns | | | | |
| 10 | 30.0% solids | None | PAA, 2.0% | Good, even | |
| | dispersion at 0.25 | | | with 5.0% | |
| | microns | | | sodium | |
| | | | | silicate added | |
| 11 | 30.0% solids | None | PAA, 0.8% | Poor when | |
| | dispersion at 0.25 | | | 5.0% sodium | |
| | microns | | | silicate added | |
| | | | | soon after | |
| | | | | PAA addition | |
| 12 | 30.0% solids | None | PAA, 0.98% | Good. No | |
| | dispersion at 0.25 | | Dispersion | settling with | |
| | microns | | irradiated at | 5.0% sodium | |
| | | | 5 Mrads. | silicate | |
| 13 | 60.0% solids | 6.0%, non- | None. | Good. 5.0% | |
| | dispersion at 0.25 | ionic. | | sodium | |
| | microns | | | silicate cause | |
| | | | | very high | |
| | | | | viscosity | |
| | | | | build and | |
| | | | | some | |
| | | | | inconsistency | |
| 14 | 30.0% solids | None. | None. | Poor. | |
| | dispersion at 0.25 | | | Immediate | |
| | microns | | | coagulation | |
| | | | | on adding | |
| | | | | sodium | |
| | | | | silicate | |
| 15 | 60.0% solids | None. | PAA, 20% | Good. 6+ | Yes |
| | dispersion at 0.25 | | | months | |
| | microns | | | | |

### Example 2

### Addition of Macromolecular Species to Aqueous PTFE Dispersions

In this Example, the stability of three commercially available PTFE dispersions was assessed upon the addition of macromolecular species. In each test run, about 25.0 g of a commercially available aqueous PTFE dispersion, diluted with distilled water to about 30.0 wt. % solids, was added to a three-inch glass phial at room temperature. As an exemplary unstabilized PTFE dispersion, AD058 from Asahi Glass Fluoropolymers USA, Inc., was used. This PTFE dispersion includes approximately 30.0 wt. % PTFE particles having an average size of between about 0.21 and 0.33 microns, but does not include a standard surfactant, except for a small amount (less than 1.0 wt. %) of APFO.

For comparative purposes, two stabilized, surfactant-containing PTFE dispersions were used. AD-1, available from Asahi Glass Fluoropolymers USA, Inc., includes approximately 60.0 wt. % PTFE particles having an average size of between about 0.2 and 0.33 microns, as well as approximately 6.0 wt. % of a non-ionic surfactant, and the pH of which was adjusted to >9.0. D3B (a copolymer of PTFE), available from Daikin America, includes approximately 60.0 wt. % PTFE particles having an average size of between about 0.21 and 0.33 microns, as well as approximately 7.0 wt. % of a non ionic surfactant.

For each test run, the amount of macromolecular species indicated in Table 2 below was added in liquid form with a pipette. The molecular weight of the macromolecular species was as follows: PAA-90,000, PEI-15,000, and PEG-1,200. The mixtures were agitated to uniformly mix the macromolecular species into the dispersions, and the results were observed. In some of the test runs, a clear water layer formed at the top of the dispersion. The height of the water layer was measured after the time periods given in Table 2 below, and the height of the water layer for each test run is given below as a percentage of the overall height of the dispersion. Thus, a lower percentage indicates the absence of, or the presence of a very small water layer in stable dispersions in which the vast majority of the PTFE particles remain completely dispersed without coagulation of the PTFE particles. A higher percentage indicates the presence of a larger water layer atop the PTFE layer, in which more of the PTFE particles have agglomerated or coagulated at the bottom of the container.

TABLE 2

| | | | | | | | | Stabilized PTFE | | |
|---|---|---|---|---|---|---|---|---|---|---|
| | | Unstabilized PTFE | | | Stabililized PTFE | | | Copolymer | | |
| | | Dispersion (AD058) | | | Dispersion (AD-1) | | | Dispersion (D3B) | | |
| | | Percentage of clear water | | | Percentage of clear water | | | Percentage of clear water | | |
| Macromolecule Added | | layer formed after: | | | layer formed after: | | | layer formed after: | | |
| (wt. %) | | 1 Day | 3 Days | 7 Days | 1 Day | 3 Days | 7 Days | 1 Day | 3 Days | 7 Days |
| None | | 8.0% | 15.6% | 28.9% | 4.4% | 13.3% | 24.4% | 8.0% | 13.5% | —% |
| PAA | 0.10% | 0.0% | 13.0% | 13.0% | | | | | | |
| | 0.50% | 2.2% | 16.3% | 13.0% | | | | | | |
| | 1.00% | 2.2% | 14.1% | 14.1% | | | | | | |
| | 1.50% | 0.0% | 12.0% | 12.0% | | | | | | |
| | 2.00% | 0.0% | 10.9% | 10.9% | | | | | | |
| | 4.00% | 0.0% | 8.5% | 9.6% | 58.7% | 63.0% | 69.6% | 6.7% | 17.8% | 24.4% |
| | 10.00% | 0.0% | 6.1% | 6.1% | | | | | | |
| PEI | 1.50% | 0.0% | 0.0% | 0.0% | 51.2% | 47.8% | 60.0% | 57.8% | 58.9% | 61.1% |
| | 3.50% | 0.0% | 0.0% | 0.0% | | | | | | |
| PEG | 2.00% | 0.0% | 11.1% | 13.3% | | | | | | |
| | 4.00% | 0.0% | 10.0% | 11.1% | 0.0% | 8.9% | 14.4% | 0.0% | 13.3% | 8.9% |

For the above test runs, a percentage of water layer height to overall liquid height of 0% to 15% is considered generally acceptable, indicating a very stable PTFE dispersion in which no water layer, or a minimal water layer, has formed, and settling of the PTFE is minimal. In these dispersions, no coagulation of the PTFE particles has occurred. Also, in these dispersions, any settled PTFE particles were easily re-dispersed into the aqueous phase with minimal stirring. A percentage of water layer height to overall liquid height of 15% to 40% indicates an increased amount of the water layer and increased settling of PTFE particles. In these dispersions, some coagulation of the PTFE has likely occurred, and the PTFE is only partially re-dispersible in the aqueous phase with stirring. A percentage of water layer height to overall liquid height greater than 40% indicates formation of a large water layer, with concurrent settling and complete coagulation of the PTFE particles.

As indicated above, each of the PAA, PEI, and PEG macromolucular species was effective in stabilizing the otherwise unstable AD058 dispersion, with the stability generally increasing with the amount of macromolecular species added after each of 1-, 3-, and 7-day standing periods. By comparison, the stability of the “stabilized” AD-1 and D3B dispersions was generally acceptable as sold, but the addition of macromolecular species increased instability due to ionic strength effects.

### Example 3

### Addition of Macromolecular Species to Aqueous PTFE Dispersions, Followed by Freezing

In this Example, the procedure of Example 2 above was followed, except that for each test run, after the macromolecular species was added to the PTFE dispersions, the dispersion was frozen in a freezer overnight. The frozen dispersions were then allowed to melt, and the water layer was measured as above after 1-, 3-, and 7-day standing periods. The results are indicated below in Table 3.

TABLE 3

| | | | | | | | Stabilized | | |
|---|---|---|---|---|---|---|---|---|---|
| | Unstabilized PTFE | | | Stabilized PTFE | | | copolymer PTFE | | |
| | Dispersion (AD058) | | | Dispersion (AD-1) | | | Dispersion (D3B) | | |
| | Percentage of clear water | | | Percentage of clear water | | | Percentage of clear water | | |
| Macromolecule Added | layer formed after: | | | layer formed after: | | | layer formed after: | | |
| (wt. %) | 1 Day | 3 Days | 7 Days | 1 Day | 3 Days | 7 Days | 1 Day | 3 Days | 7 Days |
| None: Base Dispersion | 56.0% | 56.0% | 56.0% | 36.4% | 40.9% | 46.7% | 14.8% | 15.6% | 26.7% |

| | | | | | | | | | | |
|---|---|---|---|---|---|---|---|---|---|---|
| PAA | 0.10% | 32.6% | 38.0% | 38.0% | | | | | | |
| | 0.50% | 25.6% | 30.0% | 30.0% | | | | | | |
| | 1.00% | 32.2% | 35.6% | 35.6% | 31.1% | 33.3% | 52.2% | 17.8% | 18.9% | 26.7% |
| | 1.50% | 28.3% | 32.6% | 32.6% | | | | | | |
| | 2.00% | 21.7% | 21.7% | 26.1% | | | | | | |
| | 4.00% | 10.6% | 10.6% | 10.6% | | | | | | |
| | 10.00% | 8.3% | 10.4% | 10.4% | | | | | | |
| PEG | 2.00% | 2.2% | 8.7% | 8.7% | | | | | | |
| | 4.00% | 0.0% | 0.0% | 0.0% | 6.7% | 20.0% | 57.8% | 46.7% | 55.6% | 62.2% |

As indicated in Table 3, the stability of the otherwise unstable AD058 dispersion was increased by each of the PAA and PEG macromolecular species added, even after the dispersions were subjected to a freeze/melt cycle, with the stability generally increasing with the amount of macromolecular species added. By contrast, when no macromolecular species was added to AD058, same coagulated after the freeze/melt cycle. Similarly, the “stable” AD-1 and D3B dispersions exhibited increased instability over time after freezing, both with and without addition of macromolecular species thereto.

Additional objects, advantages and other novel features of the invention will become apparent to those skilled in the art upon examination of the foregoing or may be learned with practice of the invention. The foregoing description of preferred embodiments of the invention has been presented for purposes of illustration and description. It is not intended to be exhaustive or to limit the invention to the precise form disclosed. Obvious modifications or variations are possible in light of the above teachings. The embodiments were chosen and described to provide the best illustrations of the principles of the invention and their practical application, thereby enabling one of ordinary skill in the art to utilize the invention in various embodiments and with various modifications as are suited to the particular use contemplated. All such modifications and variations are within the scope of the invention as determined by the appended claims when interpreted in accordance with the breadth to which they are fairly, legally and equitably entitled.

1. A process for stabilizing an aqueous dispersion of at least one of polytetrafluoroethylene, co-polymers of polytetrafluoroethylene, and terpolymers of polytetrafluoroethylene, comprising the steps of:
providing an aqueous dispersion of at least one of polytetrafluoroethylene, co-polymers of polytetrafluoroethylene, and terpolymers of polytetrafluoroethylene; and
adding directly to the dispersion from about 0.1 wt. % to about 20.0 wt. % of at least one macromolecular species.

2. The process of claim 1, wherein the aqueous dispersion in said providing step includes less than about 1.0 wt. % of a surfactant.

3. The process of claim 1, wherein the at least one macromolecular species is selected from at least one of the group consisting of polyacrylic acid, polyvinyl alcohol, polyethyleneimine, and polyethylene glycol, and copolymers of the foregoing.

4. The process of claim 1, wherein the molecular weight of the at least one macromolecular species is between about 300 and about 100,000.

5. The process of claim 1, wherein said adding step comprises adding said macromolecular species in aqueous solution form to the aqueous dispersion.

6. The process of claim 1, wherein said adding step comprises adding said macromolecular species in solid form to the aqueous dispersion.

7. The process of claim 1, wherein the aqueous dispersion includes from about 10.0 wt. % to about 70.0 wt. % of at least one of polytetraflouroethylene, co-polymers of polytetraflouroethylene, and terpolymers of polytetrafluoroethylene.

8. The process of claim 1, wherein the particle size of the at least one of polytetraflouroethylene, co-polymers of polytetrafluoroethylene, and terpolymers of polytetrafluoroethylene is between about 0.02 and about 1.0 microns.

9. An aqueous dispersion of at least one of polytetrafluoroethylene, co-polymers of polytetrafluoroethylene, and terpolymers of polytetrafluoroethylene, said aqueous dispersion comprising from about 0.1 wt. % to about 20.0 wt. % of at least one macromolecular species.

10. The aqueous dispersion of claim 9, wherein said aqueous dispersions is substantially free of surfactant.

11. The aqueous dispersion of claim 9, wherein said at least one macromolecular species is selected from at least one of the group consisting of polyacrylic acid, polyvinyl alcohol, polyethyleneimine, and polyethylene glycol, and copolymers of the foregoing.

12. The aqueous dispersion of claim 9, wherein the molecular weight of said at least one macromolecular species is between about 300 and about 100,000.

13. The aqueous dispersion of claim 9, wherein the particle size of said at least one of polytetraflouroethylene, co-polymers of polytetrafluoroethylene, and terpolymers of polytetrafluoroethylene is between about 0.02 and about 1.0 microns.

14. An aqueous dispersion of at least one of polytetrafluoroethylene, co-polymers of polytetrafluoroethylene, and terpolymers of polytetrafluoroethylene, said aqueous dispersion comprising from about 0.1 wt. % to about 20.0 wt. % of at least one macromolecular species and being substantially free of surfactant.

15. The aqueous dispersion of claim 14, wherein said at least one macromolecular species is selected from at least one of the group consisting of polyacrylic acid, polyvinyl alcohol, polyethyleneimine, and polyethylene glycol, and copolymers of the foregoing.

16. The aqueous dispersion of claim 14, wherein the molecular weight of said at least one macromolecular species is between about 300 and about 100,000.

17. The aqueous dispersion of claim 14, wherein the particle size of said at least one of polytetraflouroethylene, co-polymers of polytetrafluoroethylene, and terpolymers of polytetrafluoroethylene is between about 0.02 and about 1.0 microns.

18. An aqueous dispersion, comprising:
from about 10.0 wt. % to about 70.0 wt. % of at least one of polytetrafluoroethylene, co-polymers of polytetrafluoroethylene, and terpolymers of polytetrafluoroethylene;
less than about 1.0 wt. % of a surfactant; and
from about 0.1 wt. % to about 20.0 wt. % of at least one macromolecular species.

19. The aqueous dispersion of claim 18, wherein said macromolecular species is selected from at least one of the group consisting of polyacrylic acid, polyvinyl alcohol, polyethyleneimine, and polyethylene glycol, and copolymers of the foregoing.

20. The aqueous dispersion of claim 18, wherein the molecular weight of said at least one macromolecular species is between about 300 and about 100,000.

21. The aqueous dispersion of claim 18, wherein the particle size of said at least one of polytetraflouroethylene, co-polymers of polytetrafluoroethylene, and terpolymers of polytetrafluoroethylene is between about 0.02 and about 1.0 microns.
